(19) United States
(12) Patent Application Publication
(10) Pub. No.: US 2024/0152805 A1
(43) Pub. Date: May 9, 2024

(54) SYSTEMS, METHODS, AND NON-TRANSITORY COMPUTER-READABLE STORAGE DEVICES FOR TRAINING DEEP LEARNING AND NEURAL NETWORK MODELS USING OVERFITTING DETECTION AND PREVENTION

(71) Applicant: HUAWEI TECHNOLOGIES CO., LTD., Shenzhen (CN)

(72) Inventors: Hao LI, Kingston (CA); Gopi Krishnan Rajbahadur, Kingston (CA); Dayi Lin, Toronto (CA); Zhenming Jiang, Toronto (CA)

(21) Appl. No.: 18/384,634

(22) Filed: Oct. 27, 2023

Related U.S. Application Data
(60) Provisional application No. 63/422,197, filed on Nov. 3, 2022.

(51) Int. Cl. G06N 20/00

(52) U.S. Cl. CPC G06N 20/00

(57) ABSTRACT

A method for detecting and/or preventing overfitting in training of deep learning and neural network models. The method has a classifier-training method, an overfitting-detection method, and an overfitting-prevention method. The classifier-training method trains one or more classifiers using training histories and labels of one or more trained machine-learning (ML) models. The overfitting-detection method uses the trained classifiers based on the training history such as validation losses of a trained target ML model to identify an overfitting status of the trained target ML model. The overfitting-prevention method is performed during the training of a target ML model and uses the trained classifiers based on the training history of the target ML model to identify and preventing overfitting of the target ML model.

### CROSS-REFERENCE TO RELATED APPLICATION

This application claims priority to and the benefit of U.S. Provisional Patent Application Ser. No. 63/422,197, filed Nov. 3, 2022, the content of which is incorporated herein by reference in its entirety.

### FIELD OF THE DISCLOSURE

The present disclosure relates generally to artificial-intelligence (AI) systems and methods, and in particular to AI systems, methods, and non-transitory computer-readable storage devices for training deep learning and neural network models using overfitting detection and prevention.

### BACKGROUND

Artificial intelligence (AI) has been used in many areas. Generally, AI involves the use of a digital computer or a machine controlled by a digital computer to simulate, extend, and expand human intelligence, perceive an environment, obtain knowledge, and use the knowledge to obtain a best result. AI methods, machines, and systems analyze a variety of data for perception, inference, and decision making. Examples of areas for AI include robots, natural language processing, computer vision, decision making and inference, man-machine interaction, recommendation and searching, basic theories of AI, and the like. AI machines and systems usually comprise one or more AI models which may be trained using a large amount of relevant data for improving the precision of their perception, inference, and decision making.

### SUMMARY

According to one aspect of this disclosure, there is provided a first method comprising: obtaining training-history data points and corresponding labels of one or more trained machine-learning (ML) models, each label indicating an overfitting status of the corresponding training-history data point; and training one or more classifiers using the obtained training-history data points and the corresponding labels.

In some embodiments, the one or more classifiers comprise one or more time-series classifiers.

According to one aspect of this disclosure, there is provided a second method comprising: obtaining training history of a trained target ML model; obtaining validation losses from the obtained training history; and using one or more trained classifiers with the obtained validation losses inputting thereto for identifying an overfitting status of the trained target ML model.

In some embodiments, the second method further comprises: interpolating the obtained validation losses.

According to one aspect of this disclosure, there is provided a third method for performing during training of a target ML model, the third method comprising: obtaining training history of the target ML model; obtaining a portion of the training history; using one or more trained classifiers with the portion of the training history inputting thereto for generating a first set of inferences; using one or more trained classifiers with at least a portion of the training history inputting thereto for generating a second set of inferences; and using the first and second sets of inferences for detecting an overfitting status of the target ML model.

In some embodiments, the third method further comprises: obtaining the at least portion of the training history using a rolling window

In some embodiments, the third method further comprises: stopping the training of the target ML model if the overfitting status indicating occurrence of overfitting.

In some embodiments, the training history comprises validation losses; and the third method further comprises: outputting an epoch having a lowest validation loss.

The above-described methods may provide several benefits such as:
detecting overfitting without requiring human expertise, and achieve a higher accuracy for detecting overfitting;
non-intrusive detection of overfitting without requiring modification of the existing system; and
saving training time in case of the occurrence of overfitting during AI-model training by detecting and preventing overfitting during the training process.

In some embodiments, A device is provided. The device comprises: a processor coupled to a memory, the processor being configured to execute computer-readable instructions to cause the device to: obtain training-history data points and corresponding labels of one or more trained artificial-intelligence (AI) models, each label indicating an overfitting status of the corresponding training-history data point; and train one or more classifiers using the obtained training-history data points and the corresponding labels.

### BRIEF DESCRIPTION OF THE DRAWINGS

For a more complete understanding of the disclosure, reference is made to the following description and accompanying drawings, in which:

FIG. 1 is a simplified schematic diagram of an artificial intelligence (AI) system according to some embodiments of this disclosure;

FIG. 2 is a schematic diagram showing the hardware structure of the infrastructure layer of the AI system shown in FIG. 1, according to some embodiments of this disclosure;

FIG. 3 is a schematic diagram showing the hardware structure of a chip of the AI system shown in FIG. 1, according to some embodiments of this disclosure;

FIG. 4 is a schematic diagram of an AI model in the form of a deep neural network (DNN) used in the infrastructure layer shown in FIG. 2;

FIG. 5A is a plot showing the training history of a non-overfit ML model;

FIG. 5B is a plot showing the training history of an overfit ML model;

FIG. 6 is a schematic diagram showing the function structure of the AI system shown in FIG. 1 for training deep learning and neural network models using an overfitting detection and prevention method, according to some embodiments of this disclosure;

FIGS. 7A and 7B are plots showing an example of validation losses of a target ML model and an interpolation thereof, respectively; and

FIG. 8 is a schematic diagram showing the function structure of the AI system shown in FIG. 1 for training deep learning and neural network models using an overfitting detection and prevention method, according to some other embodiments of this disclosure.

### DETAILED DESCRIPTION

System Structure

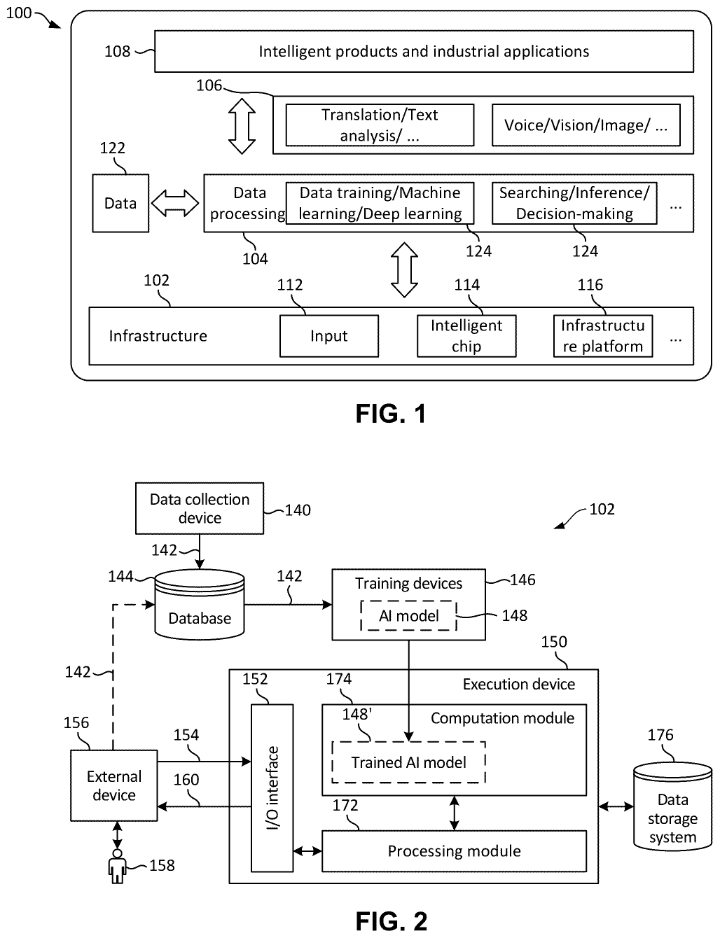

Turning now the FIG. 1, an artificial intelligence (AI) system according to some embodiments of this disclosure is shown and is generally identified using reference numeral 100. The AI system 100 comprises an infrastructure layer 102 for providing hardware basis of the AI system 100, a data processing layer 104 for processing relevant data and providing various functionalities 106 as needed and/or implemented, and an application layer 108 for providing intelligent products and industrial applications.

The infrastructure layer 102 comprises necessary input components 112 such as sensors and/or other input devices for collecting input data, computational components 114 such as one or more intelligent chips, circuitries, and/or integrated chips (ICs), and/or the like for conducting necessary computations, and a suitable infrastructure platform 116 for AI tasks.

The one or more computational components 114 may be one or more central processing units (CPUs), one or more neural processing units (NPUs; which are processing units having specialized circuits for AI-related computations and logics), one or more graphic processing units (GPUs), one or more application-specific integrated circuits (ASICs), one or more field-programmable gate arrays (FPGAs), and/or the like, and may comprise necessary circuits for hardware acceleration.

The platform 116 may be a distributed computation framework with networking support, and may comprise cloud storage and computation, an interconnection network, and the like.

In FIG. 1, the data collected by the input components 112 are conceptually represented by the data-source block 122 which may comprise any suitable data such as sensor data (for example, data collected by Internet-of-Things (IoT) devices), service data, perception data (for example, forces, offsets, liquid levels, temperatures, humidities, and/or the like), and/or the like, and may be in any suitable forms such as figures, images, voice clips, video clips, text, and/or the like.

The data processing layer 104 comprises one or more programs and/or program modules 124 in the form of software, firmware, and/or hardware circuits for processing the data of the data-source block 122 for various purposes such as data training, machine learning, deep learning, searching, inference, decision making, and/or the like.

In machine learning and deep learning, symbolic and formalized intelligent information modeling, extraction, preprocessing, training, and the like may be performed on the data-source block 122.

Inference refers to a process of simulating an intelligent inference manner of a human being in a computer or an intelligent system, to perform machine thinking and resolve a problem by using formalized information based on an inference control policy. Typical functions are searching and matching.

Decision making refers to a process of making a decision after inference is performed on intelligent information. Generally, functions such as classification, sorting, and inferencing (or prediction) are provided.

With the programs and/or program modules 124, the data processing layer 104 generally provides various functionalities 106 such as translation, text analysis, computer-vision processing, voice recognition, image recognition, and/or the like.

With the functionalities 106, the AI system 100 may provide various intelligent products and industrial applications 108 in various fields, which may be packages of overall AI solutions for productizing intelligent information decisions and implementing applications. Examples of the application fields of the intelligent products and industrial applications may be intelligent manufacturing, intelligent transportation, intelligent home, intelligent healthcare, intelligent security, automated driving, safe city, intelligent terminal, and the like.

FIG. 2 is a schematic diagram showing the hardware structure of the infrastructure layer 102, according to some embodiments of this disclosure. As shown, the infrastructure layer 102 comprises a data collection device 140 for collecting training data 142 for training an AI model 148 (such as a machine-learning (ML) model, a neural network (NN) model (for example, a convolutional neural network (CNN) model), or the like) and storing the collected training data 142 into a training database 144. Herein, the training data 142 comprises a plurality of identified, annotated, or otherwise classified data samples that may be used for training (denoted “training samples” hereinafter) and corresponding desired results. Herein the training samples may be any suitable data samples to be used for training the AI model 148, such as one or more annotated images, one or more annotated text samples, one or more annotated audio clips, one or more annotated video clips, one or more annotated numerical data samples, and/or the like. The desired results are ideal results expected to be obtained by processing the training samples by using the trained or optimized AI model 148′. One or more training devices 146 (such as one or more server computers forming the so-called “computer cloud” or simply the “cloud”, and/or one or more client computing devices similar to or same as the execution devices 150) train the AI model 148 using the training data 142 retrieved from the training database 144 to obtain the trained AI model 148 for use by the computation module 174 (described in more detail later).

As those skilled in the art will appreciate, in actual applications, the training data 142 maintained in the training database 144 may not necessarily be all collected by the data collection device 140, and may be received from other devices. Moreover, the training devices 146 may not necessarily perform training completely based on the training data 142 maintained in the training database 144 to obtain the trained AI model 148′, and may obtain training data 142 from a cloud or another place to perform model training.

The trained AI model 148′ obtained by the training devices 146 through training may be applied to various systems or devices such as an execution device 150 which may be a terminal such as a mobile phone terminal, a tablet computer, a notebook computer, an augmented reality (AR) device, a virtual reality (VR) device, a vehicle-mounted terminal, a server, or the like. The execution device 150 comprises an I/O interface 152 for receiving input data 154 from an external device 156 (such as input data provided by a user 158) and/or outputting results 160 to the external device 156. The external device 156 may also provide training data 142 to the training database 144. The execution device 150 may also use its I/O interface 152 for receiving input data 154 directly from the user 158.

The execution device 150 also comprises a processing module 172 for performing preprocessing based on the input data 154 received by the I/O interface 152. For example, in cases where the input data 154 comprises one or more images, the processing module 172 may perform image preprocessing such as image filtering, image enhancement, image smoothing, image restoration, and/or the like.

The processed data 142 is then sent to a computation module 174 which uses the trained AI model 148′ to analyze the data received from the processing module 172 for prediction. As described above, the prediction results 160 may be output to the external device 156 via the I/O interface 152. Moreover, data 154 received by the execution device 150 and the prediction results 160 generated by the execution device 150 may be stored in a data storage system 176.

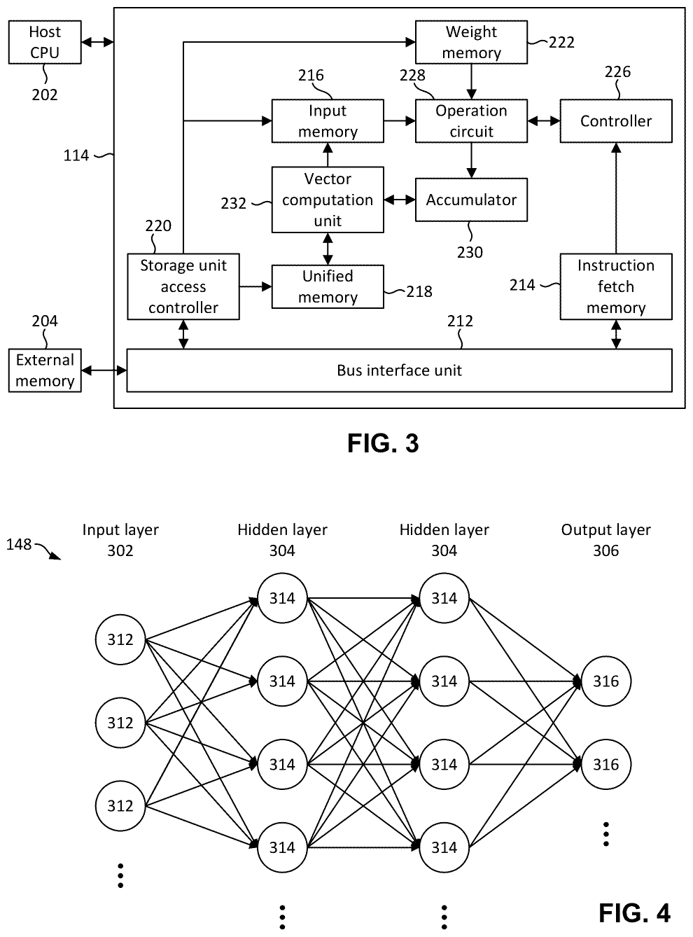

FIG. 3 is a schematic diagram showing the hardware structure of a computational component 114 according to some embodiments of this disclosure. The computational component 114 may be any processor suitable for large-scale exclusive OR operation processing, for example, a convolutional NPU, a tensor processing unit (TPU), a GPU, or the like. The computational component 114 may be a part of the execution device 150 coupled to a host CPU 202 for use as the computational module 160 under the control of the host CPU 202. Alternatively, the computational component 114 may be in the training devices 146 to complete training work thereof and output the trained AI model 148′.

As shown in FIG. 3, the computational component 114 is coupled to an external memory 204 via a bus interface unit (BIU) 212 for obtaining instructions and data (such as the input data 154 and weight data) therefrom. The instructions are transferred to an instruction fetch buffer 214. The input data 154 is transferred to an input memory 216 and a unified memory 218 via a storage-unit access controller (or a direct memory access controller, DMAC) 220, and the weight data is transferred to a weight memory 222 via the DMAC 220. In these embodiments, the instruction fetch buffer 214, the input memory 216, the unified memory 218, and the weight memory 222 are on-chip memories, and the input data 154 and the weight data may be organized in matrix forms (denoted “input matrix” and “weight matrix”, respectively).

A controller 226 obtains the instructions from the instruction fetch buffer 214 and accordingly controls an operation circuit 228 to perform multiplications and additions using the input matrix from the input memory 216 and the weight matrix from the weight memory 222.

In some implementations, the operation circuit 228 comprises a plurality of processing engines (PEs; not shown). In some implementations, the operation circuit 228 is a two-dimensional systolic array. The operation circuit 228 may alternatively be a one-dimensional systolic array or another electronic circuit that may perform mathematical operations such as multiplication and addition. In some implementations, the operation circuit 228 is a general-purpose matrix processor.

For example, the operation circuit 228 may obtain an input matrix A (for example, a matrix representing an input image) from the input memory 216 and a weight matrix B (for example, a convolution kernel) from the weight memory 222, buffer the weight matrix B on each PE of the operation circuit 228, and then perform a matrix operation on the input matrix A and the weight matrix B. The partial or final computation result obtained by the operation circuit 228 is stored into an accumulator 230.

If required, the output of the operation circuit 228 stored in the accumulator 230 may be further processed by a vector calculation unit 232 such as vector multiplication, vector addition, an exponential operation, a logarithmic operation, size comparison, and/or the like. The vector calculation unit 232 may comprise a plurality of operation processing engines, and is mainly used for calculation at a non-convolutional layer or a fully connected layer (FC) of the convolutional neural network, and may specifically perform calculation in pooling, normalization, and the like. For example, the vector calculation unit 232 may apply a non-linear function to the output of the operation circuit 228, for example a vector of an accumulated value, to generate an active value. In some implementations, the vector calculation unit 232 generates a normalized value, a combined value, or both a normalized value and a combined value.

In some implementations, the vector calculation unit 232 stores a processed vector into the unified memory 218. In some implementations, the vector processed by the vector calculation unit 232 may be stored into the input memory 216 and then used as an active input of the operation circuit 228, for example, for use at a subsequent layer in the convolutional neural network.

The data output from the operation circuit 228 and/or the vector calculation unit 232 may be transferred to the external memory 204.

FIG. 4 is a schematic diagram of the AI model 148 in the form of a deep neural network (DNN). The trained AI model 148′ generally has the same structure as the AI model 148 but may have a different set of parameters. As shown, the DNN 148 comprises an input layer 302, a plurality of cascaded hidden layers 304, and an output layer 306.

The input layer 302 comprises a plurality of input nodes 312 for receiving input data and outputting the received data to the computation nodes 314 of the subsequent hidden layer 304. Each hidden layer 304 comprises a plurality of computation nodes 314. Each computation node 304 weights and combines the outputs of the input or computation nodes of the previous layer (that is, the input nodes 312 of the input layer 302 or the computation nodes 314 of the previous hidden layer 304, and each arrow representing a data transfer with a weight). The output layer 306 also comprises one or more output node 316, each of which combines the outputs of the computation nodes 314 of the last hidden layer 304 for generating the outputs 356.

As those skilled in the art will appreciate, the AI model such as the DNN 148 shown in FIG. 4 generally requires training for optimization. For example, a training device 146 (see FIG. 2) may provide training data 142 (which comprises a plurality of training samples with corresponding desired results) to the input nodes 312 to run through the AI model 148 and generate outputs from the output nodes 316. By comparing the outputs obtained from the output nodes 316 with the desired results in the training data 142, a loss function may be established and the parameters of the AI model 148, such as the weights thereof, may be optimized by minimizing the loss function.

Non-Overfit and Overfit AI Models

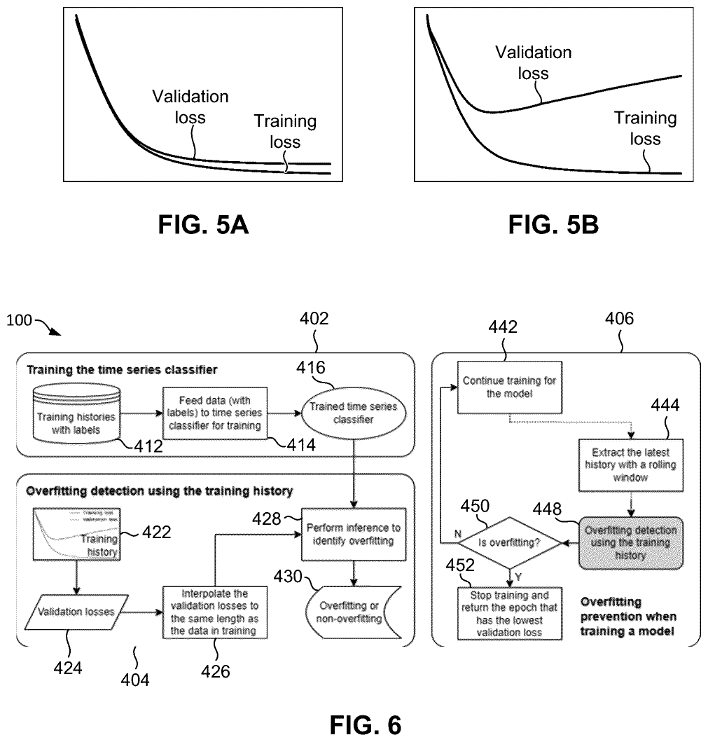

Overfitting is one of the critical issues in AI-model training such as in training ML models. FIGS. 5A and 5B shows an example of the training histories of a non-overfit ML model and an overfit ML model, respectively. As shown in FIG. 5A, a properly trained, non-overfit ML model exhibits decreasing training loss and validation loss during the training history, which are both minimized with a small gap therebetween. However, as shown in FIG. 5B, while the training loss of the overfit ML model is minimized after a certain amount of training, the validation loss thereof increases (after initial decreasing) and is much higher than the training loss during the entire training history. Such a trend of the overfit ML model shows that, although an overfit AI model works well in the training set, it may work poorly in the validation set and may lead to poor generalizability on new, unseen data with increased risk of inaccurate predictions, misleading feature importance, wasted resources, and/or the like.

In prior art, the problem of overfitting may be addressed by two methods, namely, overfitting prevention which prevents overfitting from happening, and overfitting detection which detects overfitting in a trained model. Hitherto, overfitting detection and prevention methods are often provided as a part of the cloud computing services for machine learning by various vendors such as Amazon AWS, Google Cloud Platform, and Microsoft Azure. The market size of cloud-computing services is estimated to achieve nearly 500 billion US dollars in 2022.

In prior art, correlation-based methods have been used for overfitting detection which generally compute correlation metrics (for example, Spearman's non-parametric rank correlation coefficient) between the training and validation loss to detect overfitting in ML models. Intuitively, the correlation-based methods consider that the training and validation loss are expected to be strongly correlated when there is no overfitting and the correlation should be weak when there is overfitting. The calculated correlation metrics are compared with a threshold to determine if there is overfitting.

The correlation-based methods have some limitations. For example, the correlation-based methods usually need to manually set a threshold to determine whether or not there is overfitting. Such a threshold may vary in different domains and requires human expertise to properly select the threshold.

In prior art, perturbation validation methods have also been used for overfitting detection which retrain the model with noisy data points and then observe the impact of these noisy data points on the model's accuracy to detect overfitting. The perturbation validation methods consider that overfit models would lose accuracy more slowly in the noise-injected training set.

The perturbation validation methods have some limitations. For example, the perturbation validation methods may need to retrain the model multiple times which may require extra computational resources (for example, triple of the computational cost compared to the original training process).

In prior art, early stopping methods have been used for overfitting prevention which stop training when there is no improvement in a fixed number of epochs (for example, as indicated by the patience parameter) and return the best epoch that has the lowest validation loss. The early stopping methods consider that the training will converge or become overfit when the validation loss stops improving. However, using a slow stopping criterion may increase the training time while producing only a small improvement in generalization. Moreover, the early stopping methods may incur a trade-off between model accuracy and training time, for example, using a fast stopping criterion (which shortens the training time) may result in a model with a lower accuracy.

In prior art, data augmentation methods have also been used for overfitting prevention which generate samples from the existing dataset to increase the dataset size for preventing overfitting. The data augmentation methods consider that the model is less likely to overfit all the samples when more data is added. However, the data augmentation methods usually require domain knowledge to generate the data, and the data generating process thereof consumes extra computational resource and the training time is increased.

Another group of overfitting-prevention methods in prior art are the model pruning methods, which modify the model structure by eliminating certain nodes to reduce the model complexity for preventing overfitting. These methods may be used during the training process or after the training process. The model pruning methods consider that a relatively complex model (with respect to the complexity of the dataset) is more likely overfit to the training data. However, the model pruning methods are intrusive methods as they change the original model structure.

Thus, the prior-art methods have various disadvantages such as:
Requiring human expertise to properly select the threshold;
Intrusive execution that modifies the data or the model structure; and
Requiring extra computational resources.

Training Deep Learning and Neural Network Models Using Overfitting Detection and Prevention

For ease of description and for generalization, some terms used in this disclosure are defined as follows.
Loss: The loss or loss function is the metric used to indicate the performance of an ML model on a dataset; the goal of the ML training process is to minimize a model's loss by optimizing the parameters.
Training, validation, and test sets: A dataset is typically divided into training, validation, and test sets. The training set is used in the ML training process to optimize the model's parameters. The validation set is used to assess the model for hyperparameter tuning, model selection, and other purposes. The test set is used for evaluating the final trained model.
Time-series data: Time-series data is a sequence of data points, for example, historical stock prices, sampled over time.
Time-series classifier: Time-series classifier is the classifier that may process time-series data for predicting or classifying the class of new data. Before being used, time-series classifier must be trained on time-series data with labelled classes.

According to some embodiments of this disclosure, the AI system 100 uses an overfitting detection and prevention method as shown in FIG. 6 in its AI-model training for automatically detecting overfitting for a trained ML model and for preventing overfitting from occurring during the training process. In this example, the AI system 100 comprises a time-series classifier training module 402, an overfitting-detection module 404, and an overfitting-prevention module 406.

The time-series classifier training module 402 obtains the training histories 412 (which include the training losses and validation losses) and corresponding labels (which may be a label of “overfit” or a label of “non-overfit” for each piece of data in the training histories 412) of one or more trained ML models, and feeds the obtained data training histories and corresponding labels (block 414) to a time-series classifier 416 to train the time-series classifier 416.

The overfitting-detection module 404 detects overfitting of a trained target ML model by using the trained time-series classifier 416 to perform inference for identifying whether or not there is overfitting based on the training history of the trained target ML model. In some embodiments, the overfitting-detection module 404 and related overfitting-detection method may be integrated into existing ML pipelines, for example, by running it after the pipeline's training step to determine whether the trained target ML model is overfit. In some embodiments, the overfitting-detection module 404 and related overfitting-detection method may be used as a cloud-computing service such that a user thereof only needs to provide the training history to the service to determine whether the trained target ML model is overfit.

As shown in FIG. 6, the overfitting-detection module 404 obtains the training history 422 of the trained target ML model and collects the validation losses 424 thereof over their training epochs, for input to the trained time-series classifier 416.

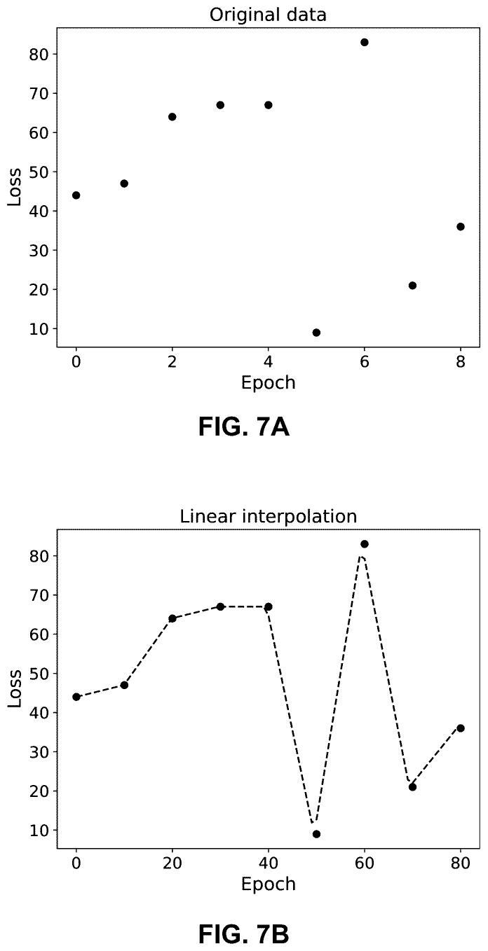

As those skilled in the art will appreciate, the length of the validation losses 424 may not be the same as that of the data used to train the time-series classifier. In some embodiments wherein the trained time-series classifier requires that the length of the inputs is the same as that of the data used for training, the overfitting-detection module 404 linearly interpolates the validation losses 424 of the target ML model to the same length as the training histories used to train the time-series classifiers 416 (block 426). FIG. 7A shows an example of validation losses 424 of a target ML model, wherein the collected validation losses are only over 8 epochs. If the time-series classifier 416 is trained over 80 epoch validation-loss values, the overfitting-detection module 404 may linearly interpolate the 8 epoch losses to 80 (see FIG. 7B) to obtain interpolated validation losses of the same length as the training histories used for training the time-series classifiers 416.

In some embodiments wherein the trained time-series classifier (such as the K-nearest neighbors and dynamic time warping (KNN-DTW) classifier) does not have such a same-length requirement, block 426 may be optional or omitted.

Referring again to FIG. 6, after collecting the validation losses 424 or after the interpolation thereof, the overfitting-detection module 404 feeds the collected or interpolated validation losses 424 to the trained time-series classifier 416 to perform inference (block 428) to determine whether or not the target ML model is overfit (block 430).

The overfitting-prevention module 406 uses the trained time-series classifier to detect overfitting during the training process of a target ML model and terminates the ML-model training if overfitting is detected. In some embodiments, the overfitting-prevention module 406 and related overfitting-prevention method may be provided as a tool for ML developers and be integrated into the training process. During the training process, the overfitting-prevention module 406 and related overfitting-prevention method may terminate the training when overfitting is detected to save training time. In some embodiments, the overfitting-prevention module 406 and related overfitting-prevention method may also be delivered as part of a cloud-computing service for ML, thereby allowing user thereof to use the overfitting-prevention module 406 and related overfitting-prevention method in conjunction with the ML training service.

As shown in FIG. 6, the overfitting-prevention module 406 monitors the training of the target ML model (block 442). To prevent overfitting, the overfitting-prevention module 406 uses a rolling window to retrieve a portion of the training history (for example, the validation losses) of the target ML model, and feeds the portion of the training history into the trained time-series classifier 416 (block 444) for generating a set of inferences. In some embodiments, the rolling window retrieves a fixed size (for example, the latest 20 epochs) of the latest training history.

The trained time-series classifier 416 uses the set of inferences to detect if any overfitting occurs in the fed history (block 448, which is substantially the same as the overfitting detection module 404 except the validation losses 424 are from block 444 rather than from block 422). If no overfitting occurs (the “N” branch of block 450), the overfitting-prevention module 406 loops back to block 442 to continue the ML-model training and move the rolling window by a fixed step size.

If there exists any overfitting (the “Y” branch of block 450), the overfitting-prevention module 406 stops the ML-model training and returns the epoch that has the lowest validation loss in the observed epochs as the best epoch (block 452).

The overfitting-prevention module 406 thus continues the ML-model training as described above until the ML-model training is completed, or until overfitting is detected and the ML-model training is terminated.

Similar to the overfitting-detection module 404, in some embodiments, the overfitting-prevention module 406 at block 448 may linearly interpolate the data obtained at block 444 before feeding it into the trained time-series classifier 416.

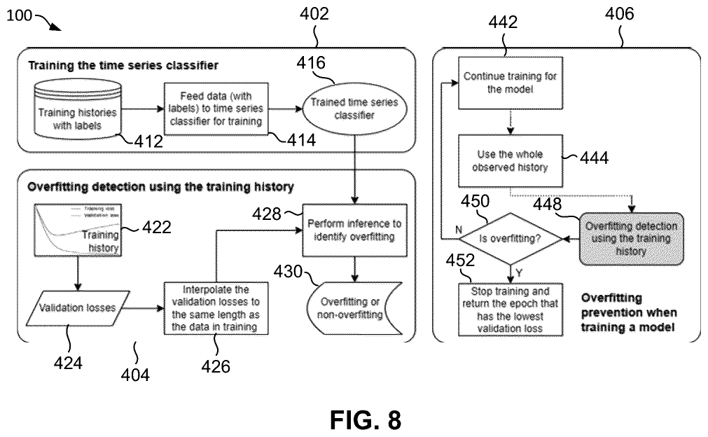

FIG. 8 is a schematic diagram showing the function structure of the AI system shown in FIG. 1 for training deep learning and neural network models using an overfitting detection and prevention method, according to some embodiments of this disclosure. The function structure of the AI system 100 and the overfitting detection and prevention method are similar to those shown in FIG. 6 except that at block 444, the entire training history (that is, from the first epoch to the current epoch in the training process) is used and fed into the trained time-series classifier 416 (block 446) for generating a second set of inferences.

Similar to the description above, in some related embodiments, the overfitting-prevention module 406 at block 448 may linearly interpolate the data obtained at block 444 before feeding it into the trained time-series classifier 416.

In some embodiments, the time-series classifier training module 402 may use simulated training histories with labels to train the time series classifier. For example, the time-series classifier training module 402 may create the simulated dataset by training NNs with different model complexities to generate the training history of overfitting and non-overfitting samples using the following steps.

Step 1—Obtaining Datasets for Overfitting Simulation.

At this step, a plurality of datasets of real-world problems are obtained. In one example, 12 datasets of real-world problems from the Proben1 benchmark set for simulating overfitting are obtained from the UCI machine learning repository (which is a machine learning repository created by University of California Irvine). As those skilled in the art understand, Proben1 is a collection of problems for NN learning with a set of rules and conventions for benchmark tests.

These obtained datasets are pre-partitioned into training, validation, and test sets (for example, respectively 50%, 25%, and 25% of the obtained datasets). Proben1 partitions each dataset (of the 12 datasets) three times in order to generate three distinct permutations. Thus, a total of 36 permuted datasets (each of the dataset includes training, validation, and test sets) from Proben1 are obtained.

Step 2—Simulating Overfitting by Training NNs.

NNs are trained with various architectures on the collected 36 datasets for varying the model complexity which in turn increases the chance of producing an overfitted model. The input/output layer contains the same number of nodes as the number of input/output coefficients of the datasets and rectified linear units (ReLUs) are used for all hidden layers. The structures of the NNs are as follows: (1) six (6) one-hidden-layer NNs with hidden nodes of 2, 4, 8, 16, 24, 32, and (2) six (6) two-hidden-layer NNs with hidden nodes (represented as first-layer hidden nodes+second-layer hidden nodes) of 2+2, 4+2, 4+4, 8+4, 8+8, 16+8. The mean square error (MSE) is used as the loss function for regression problems, and cross entropy is used as the loss function for classification problems. Additionally, stochastic gradient descent (SGD) is used as the optimizer for all of these problems. To increase the likelihood of overfitting, these 12 neural network architectures are trained on each dataset (of the collected 36 datasets) for 1,000 epochs, producing 432 training histories (that is, 432 training-history data points).

Step 3—Labelling Training Histories.

In this example, the 432 training-history data points are manually label as “overfit”, “non-overfit”, or “uncertain”, wherein the 13 training-history data points labeled with “uncertain” are discarded and the remaining 419 training-history data points and the corresponding labels are used for training the above-described time-series classifier at Step 4 described below. The remaining 419 training-history data points include 44 overfit and 375 non-overfit training histories.

Step 4—Train the Selected Time Series Classifier.

The values of validation loss are extracted from the labelled training histories. As shown in Table 1, six time-series classifiers are used for training. During the training process, the validation losses and labels are fed into each classifier. Finally, the trained time-series classifiers are saved for overfitting detection and prevention. In some embodiments, the time-series classifier may be trained on the datasets (contain training histories and labels) from other fields rather than the simulated dataset.

TABLE 1

| Classifier | Description |
|---|---|
| KNN-DTW | Using K-nearest neighbors and dynamic time |
| | warping as the distance metric |
| HMM-GMM | Using hidden Markov model for modeling time |
| | series data and Gaussian mixture model |
| | as the emissions probability density |
| TSF | Using a random forest for time series data using |
| | an ensemble of time series trees |
| TSBF | Time series bag-of-features which |
| | extracts features based on the bag-of- |
| | features approach to create a random forest |
| SAX-VSM | Symbolic aggregate approximation (SAX; which |
| | transforms the data into symbolic representations) |
| | and vector space model (VSM; which |
| | transforms the symbolic representations |
| | into vectors to calculate similarity |
| | for classification) |
| BOSSVS | Bag-of-SFA symbols in vector space (which |
| | is similar to SAX-VSM but use |
| | symbolic Fourier approximation (SFA) to |
| | transform the data instead of SAX |

In some embodiments, the AI system 100 may comprise the time-series classifier training module 402 and the overfitting-detection module 404, and may not comprise the overfitting-prevention module 406. Accordingly, the AI system 100 may use the above-described overfitting-detection method for overfitting detection. However, the AI system 100 in these embodiments may not prevent overfitting during the training of an AI model.

In some embodiments, the AI system 100 may comprise the time-series classifier training module 402 and the overfitting-prevention module 406, and may not comprise the overfitting-detection module 404. Accordingly, the AI system 100 may use the above-described overfitting prevention method to prevent overfitting during the training of an AI model. However, the AI system 100 in these embodiments may not detect overfitting of a trained AI model.

In above embodiments, training history is used to detect and prevent overfitting. In some other embodiments, additional information such as the dataset size, ML model hyperparameters, optimizer selection, and/or the like, may be included as the input to the time-series classifier for training and inference in overfitting detection and/or overfitting prevention.

In above embodiments, one or more time-series classifiers are used to determine whether there is overfitting in a trained AI model and/or during the AI-model training. In some other embodiments, other classification models, such as the NN, long short-term memory (LSTM), gated recurrent units (GRUs), and/or the like, may be used to determine whether there is overfitting in a trained AI model and/or during the AI-model training.

In various embodiments, the above-described overfitting detection and/or prevention methods may be executed by one or more suitable processors of one or more servers and/or one or more client computing devices. The above-described overfitting detection and/or prevention methods may be stored as computer-executable instructions or code on one or more non-transitory computer-readable storage media or devices. The above-described overfitting detection and/or prevention methods may be used in any suitable AI systems and/or AI services having any suitable AI models, and in fields related to the quality of ML m such as quality assurance (QA) for ML models, ML model selection, parameter tuning for ML models, and/or the like.

The above-described AI systems, methods, and non-transitory computer-readable storage devices use one or more time-series classifiers or other suitable classification models for detecting overfitting in training of deep learning and neural network models or in trained models, which provide several benefits such as:
by learning knowledge from labelled training-history data, the above-described AI systems, methods, and non-transitory computer-readable storage devices may detect overfitting without requiring human expertise, and achieve a higher accuracy for detecting overfitting;
by detecting overfitting based on the training history (which is a byproduct of the training process), detecting overfitting is non-intrusive and does not require modification of the existing system; and
by detecting and preventing overfitting during the training process, training time may be saved in case of the occurrence of overfitting.

Although embodiments have been described above with reference to the accompanying drawings, those of skill in the art will appreciate that variations and modifications may be made without departing from the scope thereof as defined by the appended claims.

What is claimed is:

1. A method comprising:
obtaining training-history data points and corresponding labels of one or more trained artificial-intelligence (AI) models, each label indicating an overfitting status of the corresponding training-history data point; and
training one or more classifiers using the obtained training-history data points and the corresponding labels.

2. The method of claim 1, wherein the one or more classifiers comprise one or more time-series classifiers.

3. A method comprising:
obtaining training history of a trained target ML model;
obtaining validation losses from the obtained training history; and
using one or more trained classifiers with the obtained validation losses inputting thereto for identifying an overfitting status of the trained target ML model.

4. The method of claim 3 further comprising:
interpolating the obtained validation losses.

5. A method for performing during training of a target ML model, the method comprising:
obtaining training history of the target ML model;
using one or more trained classifiers with at least a portion of the training history inputting thereto for generating a second set of inferences; and
using the first and second sets of inferences for detecting an overfitting status of the target ML model.

6. The method of claim 5 further comprising:
obtaining the at least portion of the training history using a rolling window.

7. The method of claim 5 further comprising:
stopping the training of the target ML model if the overfitting status indicating occurrence of overfitting.

8. The method of claim 7, wherein the training history comprises validation losses; and
wherein the method further comprises:
outputting an epoch having a lowest validation loss.

9. A device comprising: a processor coupled to a memory, the processor being configured to execute computer-readable instructions to cause the device to:
obtain training-history data points and corresponding labels of one or more trained artificial-intelligence (AI) models, each label indicating an overfitting status of the corresponding training-history data point; and
train one or more classifiers using the obtained training-history data points and the corresponding labels.
